(19) United States
(12) Patent Application Publication
(10) Pub. No.: US 2025/0193588 A1
(43) Pub. Date: Jun. 12, 2025

(54) CONTROL METHOD OF CEILING MICROPHONE

(71) Applicant: PANASONIC INTELLECTUAL PROPERTY MANAGEMENT CO., LTD., Osaka (JP)

(72) Inventors: Reo TAKIGUCHI, Fukuoka (JP); Tatsuyuki UEDA, Fukuoka (JP); Shintaro YOSHIKUNI, Fukuoka (JP)

(21) Appl. No.: 18/955,633

(22) Filed: Nov. 21, 2024

(30) Foreign Application Priority Data
Dec. 6, 2023 (JP) 2023-206252

(51) Int. Cl. H04R 1/40; H04R 29/00

(52) U.S. Cl. CPC H04R 1/406; H04R 29/005; H04R 2201/401; H04R 2420/07; H04R 2430/20

(57) ABSTRACT

A control method of a ceiling microphone includes acquiring a first voice signal collected by an array microphone including the plurality of microphone elements and an external voice signal collected in a space different from a space of the ceiling microphone; determining an output voice signal output from a speaker provided in a same space as the space of the ceiling microphone, based on the acquired first voice signal and the acquired external voice signal; and outputting the determined output voice signal to the speaker, and when it is determined that the output voice signal output from the speaker is output, stopping control of directivity of the array microphone that collects the voice of the talker and fixing a voice collecting direction in which the voice of the talker is collected.

### CROSS-REFERENCE TO RELATED APPLICATIONS

This application is based on and claims priority under 35 USC 119 from Japanese Patent Application No. 2023-206252 filed on Dec. 6, 2023, the contents of which are incorporated herein by reference.

### TECHNICAL FIELD

The present disclosure relates to a control method of a ceiling microphone.

### BACKGROUND ART

Patent Literature 1 discloses a video conference method in which a portable device is connected to a far end in video conference connection, the portable device outputs a far-end video and a far-end voice received from the far end via the video conference connection, a near-end video and a near-end voice acquired using the portable device are transmitted to the far end via the video conference connection, the portable device is connected to a video conference unit in wireless connection, and the video conference connection is transferred from the portable device to the video conference unit.

### CITATION LIST

### Patent Literature

Patent Literature 1: JP2013-93663A

### SUMMARY OF INVENTION

In Patent Literature 1, when microphones of a plurality of portable devices simultaneously capture voices, a microphone having an input with the highest volume is selected, the voice of the selected microphone is used for the video conference voice, and an echo canceller removes the voice output from a speaker from the voice for the video conference voice to remove the output voice. However, in a configuration of Patent Literature 1, depending on the volume setting of the speaker, a positional relation between the speaker and the microphone or a microphone array of each portable device, or the like, there is a possibility that the talker is erroneously recognized, or the output voice of the speaker included in the collected voice is large, and thus the transmitted voice quality is decreased.

An object of the present disclosure is to provide a control method of a ceiling microphone that prevents false recognition of a talker in a microphone installed on a ceiling. The present disclosure provides a control method of a ceiling microphone performed by a ceiling microphone includes a plurality of microphone elements each capable of collecting a voice of a talker. The control method includes acquiring a first voice signal collected by an array microphone including the plurality of microphone elements and an external voice signal collected in a space different from a space of the ceiling microphone; determining an output voice signal output from a speaker provided in a same space as the space of the ceiling microphone, based on the acquired first voice signal and the acquired external voice signal; and outputting the determined output voice signal to the speaker, and when it is determined that the output voice signal output from the speaker is output, stopping control of directivity of the array microphone that collects the voice of the talker and fixing a voice collecting direction in which the voice of the talker is collected.

These comprehensive or specific aspects may be implemented by a system, a device, a method, an integrated circuit, a computer program, or a recording medium, and may be implemented by any combination of the system, the device, the method, the integrated circuit, the computer program, and the recording medium.

According to the present disclosure, false recognition of a talker in a microphone installed on a ceiling can be prevented.

### BRIEF DESCRIPTION OF DRAWINGS

FIG. 1 is a diagram showing a system configuration example of a wireless microphone system according to Embodiment 1;

FIG. 2 is a block diagram showing an internal configuration example of a ceiling microphone according to Embodiment 1;

FIG. 3 is a diagram showing a system configuration example of a wireless microphone system according to Embodiment 2;

FIG. 4 is a block diagram showing an internal configuration example of a ceiling microphone according to Embodiment 2;

FIG. 5 is a flowchart showing a procedure example for adjusting a voice collecting level of the ceiling microphone according to Embodiments 1 and 2; and

FIG. 6 is a flowchart showing a procedure example for adjusting directivity of the ceiling microphone according to Embodiments 1 and 2.

### DESCRIPTION OF EMBODIMENTS

Hereinafter, embodiments in which a control method of a ceiling microphone is specifically disclosed in the present disclosure will be described in detail with reference to the drawings as appropriate. However, the unnecessarily detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to sufficiently understand the present disclosure, and are not intended to limit the subject matter described in claims.

### Embodiment 1

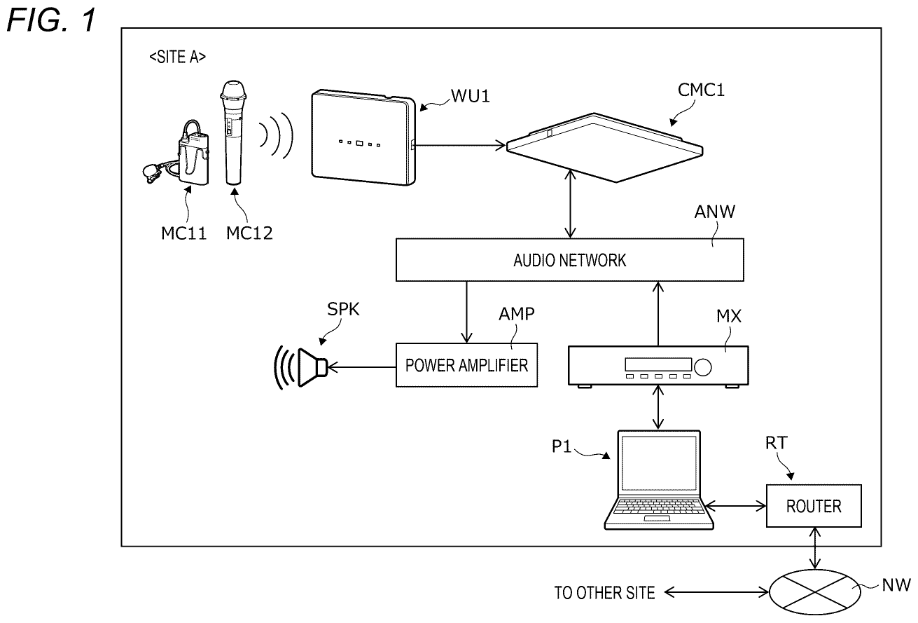

First, a system configuration example of a wireless microphone system 100 according to Embodiment 1 will be described with reference to FIG. 1. FIG. 1 is a diagram showing a system configuration example of the wireless microphone system 100 according to Embodiment 1.

The wireless microphone system 100 is provided at one site (a “site A” in FIG. 1), for example, in a conference room or a lecture in which a conference, a class, a lecture, a training, or the like in which a plurality of persons participate is performed. The wireless microphone system 100 includes a ceiling microphone CMC1, a wireless antenna unit WU1, wireless microphones MC11 and MC12, an audio network ANW, a mixer MX, a power amplifier AMP, a speaker SPK, a terminal device P1, and a router RT.

The wireless microphone system 100 may include the ceiling microphone CMC1, at least one microphone (for example, the wireless microphone MC11), at least one voice source (for example, the speaker SPK or the terminal device P1), and the audio network ANW, and the wireless microphone system 100 may be optionally configured according to the usage application. In addition, although an example is shown in which the wireless microphone system 100 is used for a call or a conference between a plurality of sites, the wireless microphone system 100 may be used at one site.

The ceiling microphone CMC1 is wire-connected between the wireless antenna unit WU1 and the audio network ANW to transmit and receive data. The wired connection here is made via, for example, a local area network (hereinafter referred to as “LAN”) cable or a universal serial bus (hereinafter referred to as “USB”) cable.

The ceiling microphone CMC1 is a so-called ceiling array microphone and is attached to a ceiling or the like. The ceiling microphone CMC1 includes a plurality of microphone elements MCE1 to MCE64, and forms directivity toward the voice source from an array microphone constituted by the plurality of microphone elements MCE1 to MCE64, thereby collecting a voice generated from the voice source. Although an example is described in which the ceiling microphone CMC1 in Embodiment 1 includes 64 microphone elements MCE1 to MCE64, the number of microphone elements included in the ceiling microphone CMC1 is not limited thereto.

The ceiling microphone CMC1 is connected to the wireless antenna unit WU1, and acquires voice signals collected by the wireless microphones MC11 and MC12 via the wireless antenna unit WU1. In addition, the ceiling microphone CMC1 acquires a voice signal of a voice collected at another site from the terminal device P1 via the mixer MX and the audio network ANW. The ceiling microphone CMC1 receives inputs of a voice signal of a voice collected by the array microphone constituted by the microphone elements MCE1 to MCE64, a voice signal of a voice collected by the wireless microphones MC11 and MC12, and a voice signal of a voice collected at another site, and manages an output system of a voice signal output from the speaker SPK and a voice signal transmitted to another site.

The ceiling microphone CMC1 determines a voice signal output from the speaker SPK among various voice signals, transmits the voice signal to the audio network ANW, and outputs the voice signal to the speaker SPK. The ceiling microphone CMC1 determines a voice signal transmitted to another site by the terminal device P1 among various voice signals, and transmits the voice signal to the terminal device P1 via the audio network ANW.

The wireless antenna unit WU1 is wirelessly communicably connected to at least one of the wireless microphones MC11 and MC12, and transmits the voice signal collected by the wireless microphones MC11 and MC12 to the ceiling microphone CMC1. Here, the wireless communication is a wireless line conforming to a wireless communication standard (for example, a time-division multiplexing communication scheme) of a time division multiple access scheme. As a wireless communication standard of the division multiplex communication scheme, for example, a digital enhanced cordless telecommunication (DECT) scheme of a frequency band of 1.9 GHZ, which is a standard of a digital cordless telephone set developed in 2011, is used. However, it is needless to say that the wireless communication standard of the time-division multiplex communication scheme is not limited to DECT.

The wireless microphones MC11 and MC12 are portable devices, and collect the voice of the talker by being worn or held by the talker. The wireless microphones MC11 and MC12 convert the collected voice into a voice signal and transmit the voice signal to the wireless antenna unit WU1.

The audio network ANW is connected to the ceiling microphone CMC1, the mixer MX, and the power amplifier AMP to enable data communication therebetween. The audio network ANW is a so-called network hub, and transmits and receives voice signals (voice data) between the ceiling microphone CMC1, the mixer MX, and the power amplifier AMP.

The mixer MX is connected to the ceiling microphone CMC1 via the audio network ANW to enable data communication therebetween, and is connected to the terminal device P1 to enable data communication therebetween. The mixer MX acquires a voice signal of a voice transmitted from the ceiling microphone CMC1 and collected at the site A and a voice signal of a voice transmitted from the terminal device P1 and collected at another site. The mixer MX converts the acquired voice signal into a digital signal, adjusts the volume or the quality of the voice, and transmits the digital signal to the ceiling microphone CMC1 and the terminal device P1.

The power amplifier AMP is connected to the ceiling microphone CMC1 and the mixer MX via the audio network ANW to enable data communication therebetween. The power amplifier AMP amplifies the voice signal transmitted from the ceiling microphone CMC1 or the mixer MX to a level at which the speaker SPK can be driven, and outputs the amplified voice signal to the speaker SPK.

The speaker SPK converts the voice signal output from the power amplifier AMP into a voice and outputs the voice. The speaker SPK outputs a voice received at the own site (that is, the site A) and a voice collected at another site.

The terminal device P1 is connected to the mixer MX and the router RT to enable data communication therebetween. The terminal device P1 is implemented by, for example, a personal computer (hereinafter, referred to as a “PC”), a notebook PC, a tablet terminal, or a smartphone, and enables data communication of voice signals, video, and the like between the own site (that is, the site A) and another site. In addition, the terminal device P1 is capable of receiving a user operation, and performs setting of a voice collecting level or the like of the ceiling microphone CMC1.

The router RT enables data communication between the terminal device P1 and a terminal device (not shown) at another site via the network NW.

The network NW is connected to the router RT installed at each site to enable data communication therebetween.

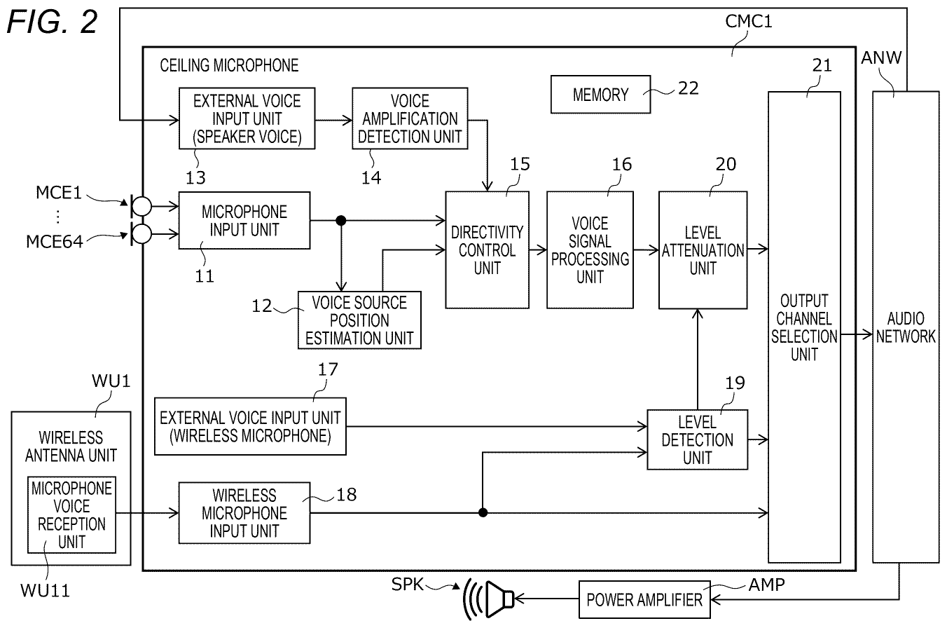

Next, an internal configuration example of the ceiling microphone CMC1 will be described with reference to FIG. 2. FIG. 2 is a block diagram showing the internal configuration example of the ceiling microphone CMC1 in Embodiment 1. The internal configuration of the ceiling microphone CMC1 shown in FIG. 2 is an internal configuration example when the ceiling microphone CMC1 is used for the usage application shown in FIG. 1, and it is needless to say that the internal configuration is not limited thereto.

The ceiling microphone CMC1 includes a microphone input unit 11, a voice source position estimation unit 12, an external voice input unit 13, a voice amplification detection unit 14, a directivity control unit 15, a voice signal processing unit 16, an external voice input unit 17, a wireless microphone input unit 18, a level detection unit 19, a level attenuation unit 20, an output channel selection unit 21, and a memory 22.

The microphone input unit 11 receives an input of a voice signal of a voice collected by the array microphone constituted by the microphone elements MCE1 to MCE64 included in the ceiling microphone CMC1. The microphone input unit 11 outputs the voice signal input from the array microphone constituted by the microphone elements MCE1 to MCE64 to the voice source position estimation unit 12 and the directivity control unit 15.

The voice source position estimation unit 12 estimates a voice source position based on the voice signal collected by the array microphone constituted by the microphone elements MCE1 to MCE64. The voice source position estimation unit 12 outputs information on the estimated voice source position to the directivity control unit 15.

The external voice input unit 13 receives an input of a voice signal (a speaker voice) output from the audio network ANW and output from the speaker SPK. The external voice input unit 13 outputs the input voice signal to the voice amplification detection unit 14.

The voice amplification detection unit 14 detects a voice amplified in a space (for example, a conference room or a lecture) in which the ceiling microphone CMC1 is installed, based on the voice signal (the speaker voice) output from the external voice input unit 13. The voice amplification detection unit 14 outputs, to the directivity control unit 15, information on a detection result of whether there is a voice signal (a speaker voice) and an amplification voice.

The directivity control unit 15 controls the directivity of the array microphone constituted by the microphone elements MCE1 to MCE64 based on the voice signal output from the microphone input unit 11, the estimated voice source position output from the voice source position estimation unit 12, and the detection result output from the voice amplification detection unit 14. The directivity control unit 15 performs control such that the directivity of the array microphone constituted by the microphone elements MCE1 to MCE64 is directed to the voice source position when the amplification voice is not detected, and stops control of the directivity of the array microphone constituted by the microphone elements MCE1 to MCE64 or performs control such that the directivity is not directed to the speaker SPK when the amplification voice is detected. The directivity control unit 15 outputs the voice signal output from the microphone input unit 11 to the voice signal processing unit 16.

The voice signal processing unit 16 performs voice processing on the voice signal output from the directivity control unit 15 and outputs the processed voice signal to the level attenuation unit 20.

The external voice input unit 17 receives an input of a voice signal of a wireless microphone input to another ceiling microphone installed at the same site. Although not shown in FIG. 1, a plurality of ceiling microphones may be installed at the same site. An example in which the plurality of ceiling microphones are installed at the same site will be described in detail in Embodiment 2.

The wireless microphone input unit 18 receives an input of voice signals transmitted from the wireless antenna unit WU1 and collected by the wireless microphones MC11 and MC12. The wireless microphone input unit 18 outputs the input voice signals to the level detection unit 19. The wireless antenna unit WU1 receives the voice signals collected by the wireless microphones MC11 and MC12 from a microphone voice reception unit WU11, and transmits the voice signals to the level detection unit 19 and the output channel selection unit 21.

The level detection unit 19 acquires a voice signal of a wireless microphone input to another ceiling microphone (not shown) and the voice signals collected by the wireless microphones MC11 and MC12. The level detection unit 19 detects whether there is a voice of a wireless microphone input to another ceiling microphone (not shown) or voices collected by the wireless microphones MC11 and MC12 based on whether a signal level of the acquired voice signal is equal to or higher than a predetermined level. The level detection unit 19 outputs the acquired voice signal and the information on the detection result to the level attenuation unit 20. The level attenuation unit 20 outputs the voice signal output from the external voice input unit 17 to the output channel selection unit 21.

The level attenuation unit 20 acquires the voice signal output from the voice signal processing unit 16 (that is, the voice signal collected by the array microphone constituted by the microphone elements MCE1 to MCE64) and voice detection presence or absence information output from the level detection unit 19 (that is, information indicating whether there is the voice of the wireless microphone input to another ceiling microphone or the voice collected by each of the wireless microphones MC11 and MC12). The level attenuation unit 20 adjusts a voice collecting level of the voice collected by the array microphone constituted by the microphone elements MCE1 to MCE64 of the ceiling microphone CMC1 based on the acquired voice detection presence or absence information. The level attenuation unit 20 outputs the voice signal output from the voice signal processing unit 16 (that is, the voice signal collected by the array microphone constituted by the microphone elements MCE1 to MCE64) to the output channel selection unit 21.

The output channel selection unit 21 acquires voice signals output from the wireless microphone input unit 18 and the level attenuation unit 20. The output channel selection unit 21 selects a voice signal output from the speaker SPK based on the acquired voice signals, and transmits the voice signal to the power amplifier AMP via the audio network ANW to output the voice signal to the speaker SPK.

The output channel selection unit 21 transmits, to the mixer MX and the terminal device P1 via the audio network ANW, voice signals collected by the ceiling microphone CMC1 and the wireless microphones MC11 and MC12 installed at the own site (that is, the site A), thereby transmitting the voice signals to another site.

The memory 22 includes, for example, a random access memory (RAM) as a work memory used when each process of the ceiling microphone CMC1 is executed, and a read only memory (ROM) that stores a program and data defining an operation of the ceiling microphone CMC1. The RAM temporarily stores data or information generated or acquired by the ceiling microphone CMC1. A program that defines an operation of the ceiling microphone CMC1 is written into the ROM. The memory 22 stores information for controlling the voice collecting level of the array microphone constituted by the microphone elements MCE1 to MCE64.

### Embodiment 2

In the wireless microphone system 100 according to Embodiment 1, an example is described in which one ceiling microphone CMC1 is installed at one site. In a wireless microphone system 100A according to Embodiment 2, an example is described in which a plurality of ceiling microphones CMC1 is installed at one site.

In the description of the wireless microphone system 100A according to Embodiment 2, the same reference numerals are given to the same configurations and functions as those of the wireless microphone system 100 according to Embodiment 1, and the description thereof will be omitted.

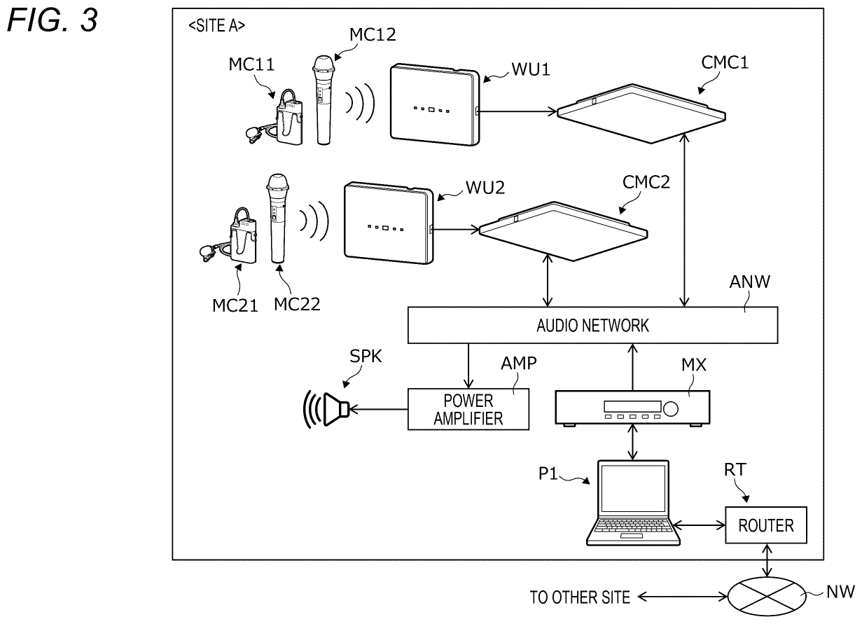

A system configuration example of the wireless microphone system 100A according to Embodiment 2 will be described with reference to FIG. 3. FIG. 3 is a diagram showing a system configuration example of the wireless microphone system 100A according to

### Embodiment 2

The wireless microphone system 100A is provided at one site (the “site A” in FIG. 3), for example, in a conference room or a lecture in which a conference, a class, a lecture, a training, or the like in which a plurality of persons participate is performed. The wireless microphone system 100A includes a plurality of ceiling microphones CMC1 and CMC2, a plurality of wireless antenna units WU1 and WU2, wireless microphones MC11, MC12, MC21, and MC22, the audio network ANW, the mixer MX, the power amplifier AMP, the speaker SPK, the terminal device P1, and the router RT. The wireless microphone system 100A may include three or more ceiling microphones.

The ceiling microphone CMC1 is connected to the ceiling microphone CMC2, the mixer MX, and the power amplifier AMP via the audio network ANW to transmit and receive data therebetween.

The ceiling microphone CMC2 is wire-connected between the wireless antenna unit WU2 and the audio network ANW to transmit and receive data. The ceiling microphone CMC2 is connected to the ceiling microphone CMC1, the mixer MX, and the power amplifier AMP via the audio network ANW to transmit and receive data therebetween. The wired connection here is made via, for example, a LAN cable or a USB cable.

The ceiling microphone CMC2 has the same configuration as the ceiling microphone CMC1. The ceiling microphone CMC2 is a so-called ceiling array microphone and is attached to a ceiling or the like. The ceiling microphone CMC2 includes the plurality of microphone elements MCE1 to MCE64, and forms directivity toward the voice source from the array microphone constituted by the microphone elements MCE1 to MCE64, thereby collecting a voice generated from the voice source. Although an example is described in which the ceiling microphone CMC2 in Embodiment 2 includes 64 microphone elements MCE1 to MCE64, the number of microphone elements included in the ceiling microphone CMC2 is not limited thereto.

The ceiling microphone CMC2 is connected to the wireless antenna unit WU2, and acquires voice signals collected by the wireless microphones MC21 and MC22 via the wireless antenna unit WU2. In addition, the ceiling microphone CMC2 acquires a voice signal of a voice collected at another site from the terminal device P1 via the mixer MX and the audio network ANW. The ceiling microphone CMC2 receives inputs of a voice signal of a voice collected by the array microphone constituted by the microphone elements MCE1 to MCE64, a voice signal of a voice collected by the wireless microphones MC21 and MC22, and a voice signal of a voice collected at another site, and manages an output system of a voice signal output from the speaker SPK and a voice signal transmitted to another site.

The ceiling microphone CMC2 determines a voice signal output from the speaker SPK among various voice signals, transmits the voice signal to the audio network ANW, and outputs the voice signal to the speaker SPK. The ceiling microphone CMC2 determines a voice signal transmitted to another site by the terminal device P1 among various voice signals, and transmits the voice signal to the terminal device P1 via the audio network ANW.

The wireless antenna unit WU2 is wirelessly communicably connected to at least one of the wireless microphones MC21 and MC22, and transmits the voice signal collected by the wireless microphones MC21 and MC22 to the ceiling microphone CMC2. Here, the wireless communication is a wireless line conforming to a wireless communication standard (for example, a time-division multiplexing communication scheme) of a time division multiple access scheme.

The wireless microphones MC21 and MC22 are portable devices that collect the voice of the talker by being worn or held by the talker. The wireless microphones MC21 and MC22 convert the collected voice into a voice signal and transmit the voice signal to the wireless antenna unit WU2.

The audio network ANW is connected to the ceiling microphones CMC1 and CMC2, the mixer MX, and the power amplifier AMP to enable data communication therebetween. The audio network ANW is a so-called network hub, and transmits and receives voice signals (voice data) between the ceiling microphones CMC1 and CMC2, the mixer MX, and the power amplifier AMP.

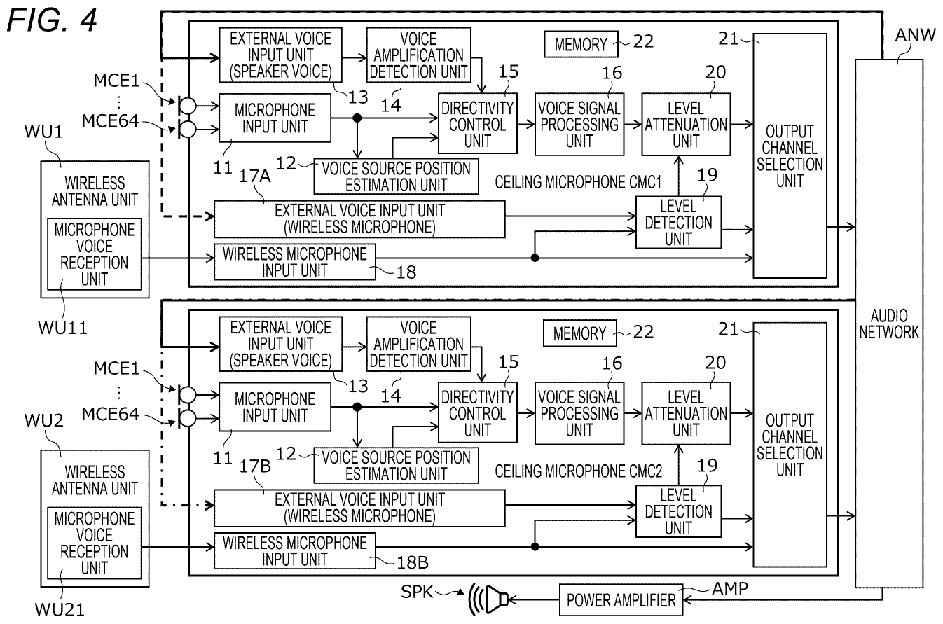

Next, an internal configuration example of the ceiling microphones CMC1 and CMC2 will be described with reference to FIG. 4. FIG. 4 is a block diagram showing an internal configuration example of the ceiling microphones CMC1 and CMC2 in Embodiment 2. The internal configuration of the ceiling microphones CMC1 and CMC2 shown in FIG. 4 is an internal configuration example when the ceiling microphones CMC1 and CMC2 are used for the usage application shown in FIG. 2, and it is needless to say that the internal configuration is not limited thereto.

The ceiling microphone CMC1 includes the microphone input unit 11, the voice source position estimation unit 12, the external voice input unit 13, the voice amplification detection unit 14, the directivity control unit 15, the voice signal processing unit 16, an external voice input unit 17A, the wireless microphone input unit 18, the level detection unit 19, the level attenuation unit 20, the output channel selection unit 21, and the memory 22.

The external voice input unit 17A receives inputs of voice signals received by the wireless antenna unit WU2 connected to the other ceiling microphone CMC2 installed at the same site and collected by the wireless microphones MC21 and MC22.

The ceiling microphone CMC2 includes the microphone input unit 11, the voice source position estimation unit 12, the external voice input unit 13, the voice amplification detection unit 14, the directivity control unit 15, the voice signal processing unit 16, an external voice input unit 17B, the wireless microphone input unit 18, the level detection unit 19, the level attenuation unit 20, the output channel selection unit 21, and the memory 22.

The external voice input unit 17B receives inputs of voice signals received by the wireless antenna unit WU1 connected to the other ceiling microphone CMC1 installed at the same site and collected by the wireless microphones MC11 and MC12.

The wireless microphone input unit 18B receives an input of voice signals transmitted from the wireless antenna unit WU2 and collected by the wireless microphones MC21 and MC22. The wireless microphone input unit 18B outputs the input voice signals to the level detection unit 19. The wireless antenna unit WU2 receives the voice signals collected by the wireless microphones MC21 and MC22 from a microphone voice reception unit WU21, and transmits the voice signals to the level detection unit 19 and the output channel selection unit 21.

When a plurality of ceiling microphones are installed at the same site, as the ceiling microphones, all the wireless microphones, all the array microphones, and a ceiling microphone serving as a master that determines the voice signal output from the speaker SPK among the voice signals transmitted from the other sites, and a ceiling microphone that transmits the voice signal received by the wireless microphone and the array microphone to the ceiling microphone serving as the master and does not determine the voice signal output from the speaker may be set.

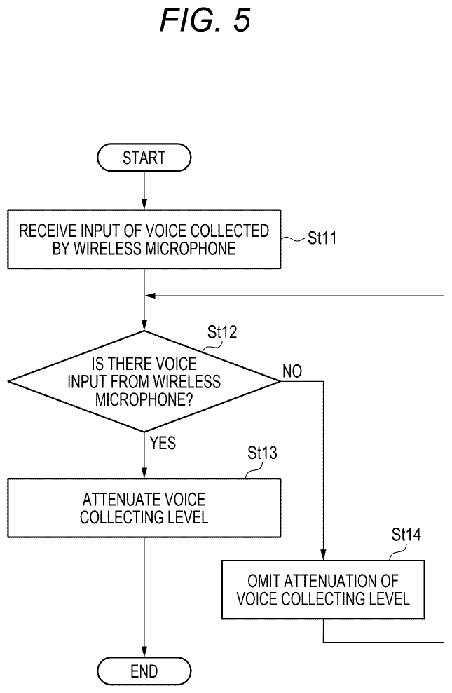

Next, control of the ceiling microphones CMC1 and CMC2 will be described with reference to FIG. 5. FIG. 5 is a flowchart showing an example of a procedure for adjusting a voice collecting level of the ceiling microphones CMC1 and CMC2 in Embodiments 1 and 2. The example of the procedure for adjusting the voice collecting level shown in FIG. 5 is executed by each ceiling microphone. Here, in order to make the description easy to understand, the example of the procedure for adjusting the voice collecting level executed by the ceiling microphone CMC1 will be described. The same applies to the ceiling microphone CMC2.

The ceiling microphone CMC1 receives an input of voice signals of voices collected by the wireless microphones MC11 and MC12 (St11). The ceiling microphone CMC1 determines whether there is a voice signal input from each of the wireless microphones at the same site, that is, the wireless microphones MC11 and MC12 or the wireless microphones MC21 and MC22 (St12).

When it is determined that there is a voice signal input from the wireless microphone at the same site (St12, YES), the ceiling microphone CMC1 executes control to attenuate a voice collecting level of the array microphone constituted by the microphone elements MCE1 to MCE64 of the ceiling microphone CMC1 to a predetermined voice collecting level set in advance (St13).

When it is determined that there is no voice signal input from the wireless microphone at the same site (St12, NO), the ceiling microphone CMC1 omits the control of attenuating the voice collecting level of the array microphone constituted by the microphone elements MCE1 to MCE64 of the ceiling microphone CMC1 (St14). When the current voice collecting level is attenuated to the predetermined voice collecting level, the ceiling microphone CMC1 may execute control to return (amplify) the voice collecting level to a voice collecting level before attenuation.

As described above, when a voice signal is input from a wireless microphone installed at the own site, the ceiling microphones CMC1 and CMC2 according to Embodiments 1 and 2 can preferentially output the voice signal of the wireless microphone from the speaker SPK or transmit the voice signal to another site by attenuating the voice collecting level of the ceiling microphones CMC1 and CMC2. Accordingly, the ceiling microphones CMC1 and CMC2 according to Embodiments 1 and 2 can improve the voice quality of the voice signal output from the speaker SPK or transmitted to another site.

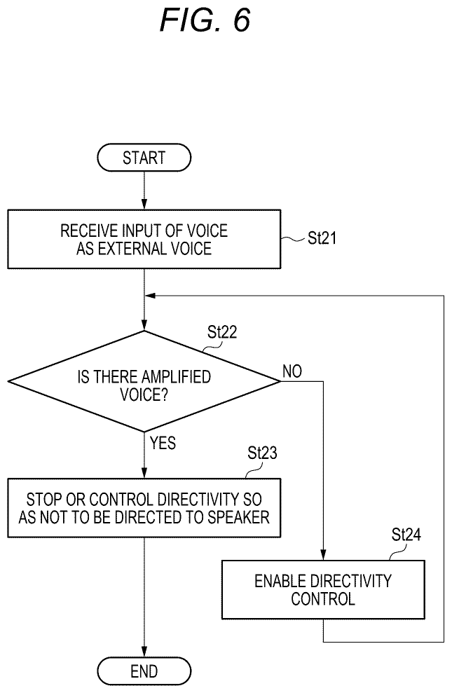

Next, control of the ceiling microphones CMC1 and CMC2 will be described with reference to FIG. 6. FIG. 6 is a flowchart showing an example of a procedure for adjusting the directivity of the ceiling microphones CMC1 and CMC2 in Embodiments 1 and 2. The example of the procedure for adjusting the voice collecting level shown in FIG. 6 is executed by each ceiling microphone. Here, in order to make the description easy to understand, the example of the procedure for adjusting the voice collecting level executed by the ceiling microphone CMC1 will be described. The same applies to the ceiling microphone CMC2.

The ceiling microphone CMC1 receives an input of a voice signal (a speaker voice) output from the speaker SPK installed at the own site as an external voice (St21). The ceiling microphone CMC1 determines whether there is an amplified voice based on the input voice signal (St22).

When it is determined that there is an amplified voice (St22, YES), the ceiling microphone CMC1 stops the control of the directivity of the array microphone constituted by the microphone elements MCE1 to MCE64 of the ceiling microphone CMC1 or controls the directivity of the array microphone so as not to be directed to the speaker SPK to fix a voice collecting direction (St23).

On the other hand, when it is determined that there is no amplified voice (St22, NO), the ceiling microphone CMC1 enables the control of the directivity of the array microphone constituted by the microphone elements MCE1 to MCE64 of the ceiling microphone CMC1, estimates a position of a voice source (that is, a talker), and forms the directivity of the array microphone at the estimated position of the talker (St24).

As described above, when the voice is output from the speaker SPK installed at the own site, the ceiling microphones CMC1 and CMC2 according to Embodiments 1 and 2 can more effectively prevent the voice output from the speaker SPK from being erroneously recognized as a voice source (a talker) by stopping the formation of the directivity of the ceiling microphones CMC1 and CMC2 or controlling the directivity of the ceiling microphone CCMC so as not to be directed to the speaker SPK. Accordingly, the ceiling microphones CMC1 and CMC2 can improve the voice quality of the voice signal output from the speaker SPK or transmitted to another site.

### (Note)

The following techniques are disclosed based on the above description of the embodiments.

### (Technique 1)

A control method of the ceiling microphone CMC1 performed by the ceiling microphone CMC1 including a plurality of microphone elements MCE1 to MCE64 each capable of collecting a voice of a talker, the control method including:

acquiring a first voice signal collected by an array microphone including the plurality of microphone elements MCE1 to MCE64 and an external voice signal collected in a space different from a space of the ceiling microphone CMC1;

determining an output voice signal output from a speaker SPK provided in the same space as the space of the ceiling microphone CMC1, based on the acquired first voice signal and the acquired external voice signal; and outputting the determined output voice signal to the speaker SPK, and when it is determined that the output voice signal output from the speaker SPK is output, stopping control of directivity of the array microphone that collects the voice of the talker or controlling the directivity so as not to be directed to the speaker SPK to fix a voice collecting direction in which the voice of the talker is collected.

With this configuration, the ceiling microphone CMC1 can more effectively prevent the voice output from the speaker SPK provided in the same space, that is, at the same site from being erroneously recognized as the voice of the talker) and prevent the formation of the directivity of the array microphone constituted by the microphone elements MCE1 to MCE64 toward a position of the speaker SPK.

### (Technique 2)

The control method the ceiling microphone CMC1 according to Technique 1, in which

when it is determined that the output voice signal output from the speaker SPK is not output, control of the directivity of the array microphone that collects the voice of the talker is enabled;

a direction of the speaker is estimated based on the first voice signal; and

the directivity of the array microphone is formed in the estimated direction of the talker.

With this configuration, when the voice is not output from the speaker SPK provided in the same space, that is, at the same site, the ceiling microphone CMC1 estimates a position of the talker at the same site, and forms the directivity of the array microphone constituted by the plurality of microphone elements MCE1 to MCE64 toward the estimated position of the talker, so that the voice of the talker can be more effectively collected.

### (Technique 3)

The control method of the ceiling microphone CMC1 according to any one of (Technique 1) to (Technique 2), in which

the ceiling microphone CMC1 is further communicably connected to at least one first microphone (the wireless microphones MC11 and MC12) provided in the same space as the space of the ceiling microphone CMC1, an input of a second voice signal collected by the first microphone (the wireless microphones MC11 and MC12) is received, and the output voice signal output from the speaker SPK is determined based on the first voice signal, the second voice signal, and the external voice signal; and

when it is determined that the second voice signal is input, a voice collecting level of the voice collected by the array microphone is attenuated to a predetermined voice collecting level.

With this configuration, when the voice of the talker is collected by the wireless microphones MC11 and MC12 provided in the same space, that is, at the same site, the ceiling microphone CMC1 can preferentially transmit the voice collected by the wireless microphones MC11 and MC12 to another site by attenuating the voice collecting level of the ceiling microphone CMC1. Accordingly, the ceiling microphone CMC1 can transmit a voice of higher quality to another site.

### (Technique 4)

The control method of the ceiling microphone CMC1 according to any one of

(Technique 1) to (Technique 3), in which

when it is determined that the second voice signal is not input, a voice collecting level of the voice collected by the array microphone is amplified to a voice collecting level before the attenuation.

With this configuration, when the voice of the talker is not collected by the wireless microphones MC11 and MC12 provided in the same space, that is, at the same site, the ceiling microphone CMC1 returns the voice collecting level of the ceiling microphone CMC1 to the voice collecting level before the attenuation, so that the voice at the site can be more effectively collected.

### (Technique 5)

The control method of the ceiling microphone CMC1 according to any one of (Technique 1) to (Technique 4), in which

the ceiling microphone CMC1 is further communicably connected to another ceiling microphone CMC2 provided in the same space, an input of a third voice signal collected by at least one second microphone (the wireless microphones MC21 and MC22) communicably connected to the other ceiling microphone CMC2 is further received, and the output voice signal output from the speaker SPK is determined based on the first voice signal, the second voice signal, the third voice signal, and the external voice signal,

when it is determined that the third voice signal is input, a voice collecting level of the voice collected by the array microphone is attenuated to a predetermined voice collecting level.

With this configuration, when the voice of the talker is not collected by the wireless microphones MC21 and MC22 provided in the same space, that is, at the same site, the ceiling microphone CMC1 returns the voice collecting level of the ceiling microphone CMC1 to the voice collecting level before the attenuation, so that the voice at the site can be more effectively collected.

### (Technique 6)

The control method of the ceiling microphone CMC1 according to any one of (Technique 1) to (Technique 5), in which

when it is determined that the third voice signal is not input, a voice collecting level of the array microphone is amplified to a voice collecting level before the attenuation.

With this configuration, when the voice of the talker is not collected by the wireless microphones MC11 and MC12 provided in the same space, that is, at the same site, the ceiling microphone CMC1 returns the voice collecting level of the ceiling microphone CMC1 to the voice collecting level before the attenuation, so that the voice at the site can be more effectively collected.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, constituent elements in the embodiment described above may be freely combined without departing from the gist of the invention.

### INDUSTRIAL APPLICABILITY

The present disclosure is useful as a control method of a ceiling microphone that prevents false recognition of a talker in a microphone installed on a ceiling.

What is claimed is:

1. A control method of a ceiling microphone performed by a ceiling microphone including a plurality of microphone elements each capable of collecting a voice of a talker, the control method comprising:
acquiring a first voice signal collected by an array microphone including the plurality of microphone elements and an external voice signal collected in a space different from a space of the ceiling microphone;
determining an output voice signal output from a speaker provided in a same space as the space of the ceiling microphone, based on the acquired first voice signal and the acquired external voice signal; and
outputting the determined output voice signal to the speaker, and when it is determined that the output voice signal output from the speaker is output, stopping control of directivity of the array microphone that collects the voice of the talker and fixing a voice collecting direction in which the voice of the talker is collected.

2. The control method of a ceiling microphone according to claim 1, further comprising:
when it is determined that the output voice signal output from the speaker is not output, enabling control of the directivity of the array microphone that collects the voice of the talker;
estimating a direction of the speaker based on the first voice signal; and
forming the directivity of the array microphone in the estimated direction of the speaker.

3. The control method of a ceiling microphone according to claim 1, wherein
the ceiling microphone is further communicably connected to at least one first microphone provided in the same space as the space of the ceiling microphone, an input of a second voice signal collected by the first microphone is received, and the output voice signal output from the speaker is determined based on the first voice signal, the second voice signal, and the external voice signal; and
when it is determined that the second voice signal is input, a voice collecting level of the voice collected by the array microphone is attenuated to a predetermined voice collecting level.

4. The control method of a ceiling microphone according to claim 3, wherein
when it is determined that the second voice signal is not input, a voice collecting level of the voice collected by the array microphone is amplified to a voice collecting level before the attenuation.

5. The control method of a ceiling microphone according to claim 3, wherein
the ceiling microphone is further communicably connected to another ceiling microphone provided in the same space, an input of a third voice signal collected by at least one second microphone communicably connected to the other ceiling microphone is further received, and the output voice signal output from the speaker is determined based on the first voice signal, the second voice signal, the third voice signal, and the external voice signal,
when it is determined that the third voice signal is input, a voice collecting level of the voice collected by the array microphone is attenuated to a predetermined voice collecting level.

6. The control method of a ceiling microphone according to claim 5, wherein
when it is determined that the third voice signal is not input, a voice collecting level of the array microphone is amplified to a voice collecting level before the attenuation.
